(19) United States
(12) Patent Application Publication
(10) Pub. No.: US 2018/0012178 A1
(43) Pub. Date: Jan. 11, 2018

(54) PARCEL DELIVERY SYSTEM AND METHOD

(71) Applicant: Anderson Ramirez, Duluth, GA (US)

(72) Inventor: Anderson Ramirez, Duluth, GA (US)

(21) Appl. No.: 15/646,609

(22) Filed: Jul. 11, 2017

Related U.S. Application Data
(60) Provisional application No. 62/360,623, filed on Jul. 11, 2016.

(51) Int. Cl. G06Q 10/08; G06K 19/06; G06Q 30/02; H04W 4/02

(52) U.S. Cl. CPC G06Q 10/0833; G06Q 30/0282; G06K 19/06009; H04W 4/02

(57) ABSTRACT

A parcel delivery system and method. The parcel delivery system and method includes a user application loaded on mobile computing devices of a plurality of users and a service application loaded on mobile computing devices of a plurality of service providers. The users may create digital posts including information about parcels they would like to ship through the user application. The digital posts are accessible the user service provides on the service application. The service providers may select a digital post, pick up the parcel and deliver the parcel to a destination. The user may track the service provider during delivery via the user and service applications.

### CROSS-REFERENCE TO RELATED APPLICATION

This application claims the benefit of priority of U.S. provisional application No. 62/360,623, filed Jul. 11, 2016, the contents of which are herein incorporated by reference.

### BACKGROUND OF THE INVENTION

The present invention relates to delivering parcels and, more particularly, to a computer system and method for delivering parcels.

Parcels are currently delivered using private delivery companies and government postal services. Cost of deliveries are high due to overhead. There are many real-world services that a user can access through a mobile computing device. In some examples, a user can request transportation services or delivery services by operating a mobile computing device. The mobile computing provided services lower overhead costs and therefore lower costs to the user.

As can be seen, there is a need for an improved system and method for delivering parcels.

### SUMMARY OF THE INVENTION

In one aspect of the present invention, a method of delivery of a parcel, the method being performed using a computing system and comprising: receiving, by the computing system, user data from mobile computing devices that are operated by individuals, the user data being generated by a user application on a respective mobile computing device of each individual, wherein receiving user data includes receiving a position of the individual and a destination position of the parcel from the respective mobile computing device of each individual; producing, by the computing system, a selectable list of digital posts comprising the user data on mobile computing devices that are operated by a group of service providers, the selectable list being displayed on a service provider application on a respective mobile computing device of each service provider in the group; selecting, by one of the service providers, one of the digital posts on the respective service provider application on the respective mobile computer device of the service provider; and producing, by the computing system, a map on the service application on the mobile computing device of the service provider and the user application on the mobile computing device of user, wherein the map displays the current position information of the service provider and the destination position of the parcel.

These and other features, aspects and advantages of the present invention will become better understood with reference to the following drawings, description and claims.

### BRIEF DESCRIPTION OF THE DRAWINGS

FIG. 1 is a flow chart of the user and the service providers process during a delivery order; and

FIG. 2 is a continuation of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a computing system including a plurality of computers each having a processor and a memory. Each of the computers may include servers, desktops, laptops, and mobile computing devices, such as, a tablet and smart phone. The computers may include applications loaded on the memory. The applications are a program product including a machine-readable program code for causing, when executed, the computers to perform steps. The computers communicate and exchange data over the Internet, extranet, intranet, host server, internet cloud and the like.

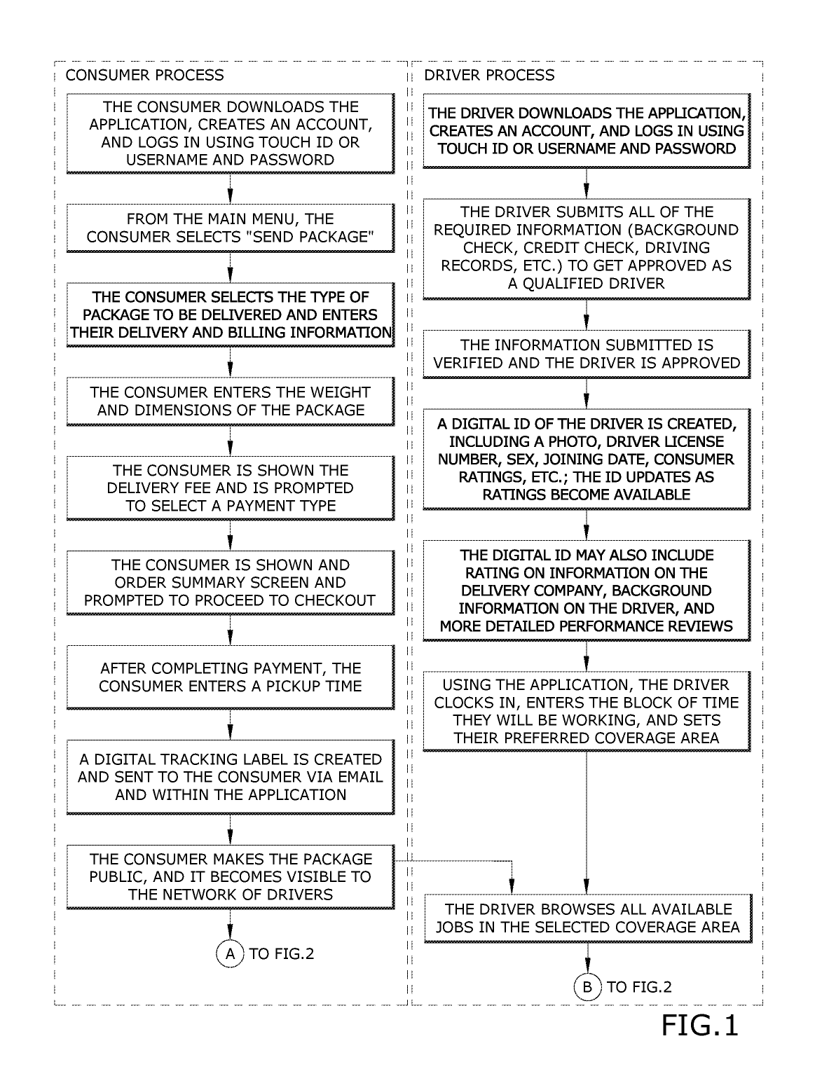

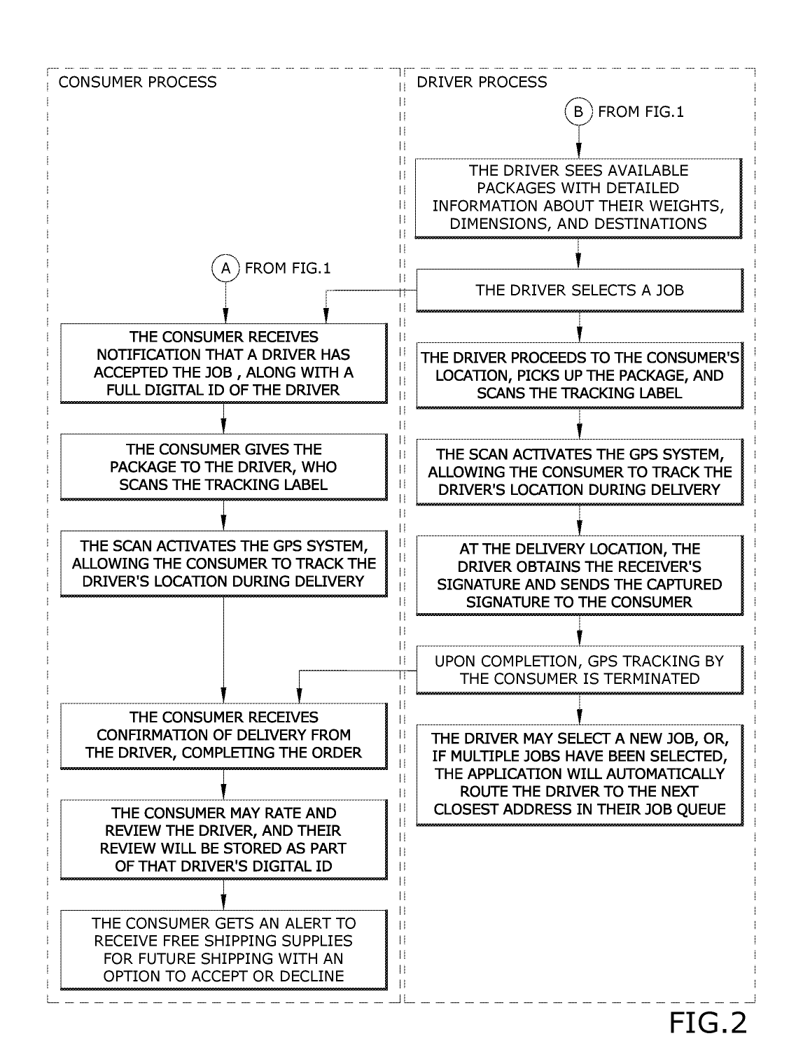

Referring to FIGS. 1 and 2, the system and method includes a plurality of consumers (users) that download and load a user application on a respective mobile computing device. The user may create an account including a user identification and a password. The user enters user data on the user application on the mobile computing device which is sent to a computing system. The computing system may include a main server. The user data may include, but is not limited to, a pick up time, a final destination of the parcel, the type of parcel, the weight of the parcel, and the dimensions of the parcel. A price may be generated by the computing system based on the user data. The user may enter billing information and select a payment type to make payment for the delivery of the parcel. An order summary screen is generated on the user application prompting the user to proceed to checkout.

After the user data has been entered into the computer system and the payment has been made, a digital tracking label is generated. The digital tracking label may be sent to the user via email and may be viewable to the user within the user application. The digital tracking label includes a position of the individual and the final destination of the parcel. The digital tracking label may further include a scannable barcode including the final destination (coordinates or address) of the parcel. The user may then publish a digital post to a group of service providers. The digital post includes the user data mentioned above. The digital posts of the users are added to a selectable list. The selectable list is produced by the computing system and includes a plurality of digital posts generated by a plurality of users. The selectable list is accessible by a group of service providers on a service provider application on a respective mobile computing device of each service provider in the group.

The system and method includes a plurality of drivers (service providers) that download and load a service application on a respective mobile computing device. The service provider may create an account including a user identification and a password. The service provider enters provider data on the service application which is sent to the computing system. The provider data may include, but is not limited to, a name, a sex, a driver's license identification number, a driver's license number and the like. A background check, credit check and a driving record may be required to approve the service provider and allow the service provider access to the selectable list. Once the service provider is approved, a digital identification (ID) is generated. The digital ID may include, but is not limited to, a photo of the service provider, a driver's license number, a sex, a joining date, a consumer rating and the like. The digital ID updates as the ratings of the service providers are entered into the computer system by the users.

As mentioned above, the selectable list is accessible by the group of service providers on the service provider application. The service provider application uses a global positioning system of the mobile computing device to determine a position of the service provider. The mobile computing device is able to determine a location of the parcels to be delivered for each of the digital posts. The plurality of digital posts that are determined to be within the closest proximity of the service provider may be displayed. For example, the plurality of digital posts may be sorted within the selectable list based on how close the pickup of the parcels are relative to a current position of the service provider.

Using the service provider application, the service provider may clock in, enter blocks of time they will be working and sets their preferred coverage area. The service provider browses the available jobs (digital posts) in the selected coverage area. The digital posts may provide detailed information about the parcels weights, dimensions and destinations to the service provides. The service provider then may select a digital post. Once the digital post has been selected, the digital ID is sent from the service provider application to the user provider application. The user is then prompted to approve or deny the service providers offer of services. If the user accepts the services, the service provider is notified via the service provider application. The service provider proceeds to the user's location, picks up the package and scans the computer readable code of the digital tracking label with their respective mobile computing device.

Once the computer readable code has been scanned, a map is produced on the service application on the mobile computing device of the service provider and the user application on the mobile computing device of user. Generating data from the global positioning system of the mobile computing device of the service provider, the map displays the current position information of the service provider and the destination position of the parcel. Using the dual mapping system, the service provider may follow the map to the destination of the parcel while the user views the service provider traveling to said destination. The system of the present invention allows the user to track their parcel, which prevents theft and provides a peace of mind to the user.

In certain embodiments, a signature prompt is produced on the service application on the mobile computing device of the service provider when the computing system determines the service provider has reached the final destination position. The recipient of the parcel may use a touch screen of the mobile computing device of the service provider to sign their name. A copy of a signature may be sent from the service application to the user application on the mobile computing device of the user. Additionally, a ratings prompt may be produced and sent to the user application on the mobile computing device of the user with the copy of the signature. The user may then provide a rating, such as a numerical rating, based on the performance of the service provider. An entered rating by the user of the service provider sent from the user application is received by the computing system. The entered rating is averaged with the rating of the service provider and the service provider rating is updated to be published to other users.

It should be understood, of course, that the foregoing relates to exemplary embodiments of the invention and that modifications may be made without departing from the spirit and scope of the invention as set forth in the following claims.

What is claimed is:

1. A method of delivery of a parcel, the method being performed using a computing system and comprising:
receiving, by the computing system, user data from mobile computing devices that are operated by individuals, the user data being generated by a user application on a respective mobile computing device of each individual, wherein receiving user data includes receiving a position of the individual and a destination position of the parcel from the respective mobile computing device of each individual;
producing, by the computing system, a selectable list of digital posts comprising the user data on mobile computing devices that are operated by a group of service providers, the selectable list being displayed on a service provider application on a respective mobile computing device of each service provider in the group;
selecting, by one of the service providers, one of the digital posts on the respective service provider application on the respective mobile computer device of the service provider; and
producing, by the computing system, a map on the service application on the mobile computing device of the service provider and the user application on the mobile computing device of user, wherein the map displays the current position information of the service provider and the destination position of the parcel.

2. The method of claim 1, further comprising the step of
producing, by the computing system, a signature prompt on the service application on the mobile computing device of the service provider when the computing system determines the service provider has reached the destination position; and
sending, by the computing system, a copy of a signature from the service application on the mobile computing device of the service provider to the user application on the mobile computing device of the user.

3. The method of claim 1, further comprising the step of:
producing, by the computer system, a digital tracking label comprising a computer readable code comprising the destination position of the parcel when the digital post is produced; and
scanning the computer readable code by the service application on the mobile computing device of the service provider, wherein the step of scanning the computer readable code prompts the map to be generated on the service application on the mobile computing device of the service provider and the user application on the mobile computing device of user.

4. The method of claim 1, wherein the user data further comprises a type of the parcel, a size of the parcel, a weight of the parcel or a combination thereof.

5. The method of claim 2, further comprising the steps of:
receiving, by the computing system, provider data from the mobile computing devices that are operated by the group of service providers, the provider data being generated by the service application on the respective mobile computing device of each service provider in the group, wherein the provider data includes identifying information of the service provider;
generating, by the computing system, a driver identification (ID) comprising at least a portion of the provider data and a rating of the service provider; and
sending, by the computing system, the digital ID to the user application on the mobile computing device of the user after the service provider selects the digital post.

6. The method of claim 5, further comprising the steps of:
producing, by the computing system, a ratings prompt on the user application on the mobile computing device of the user with the copy of the signature; and
receiving, by the computing system, an entered rating by the user of the service provider sent from the user application on the mobile computing device of the user, wherein the entered rating is averaged with the rating of the service provider.
